(19) United States
(12) Patent Application Publication
(10) Pub. No.: US 2026/0044975 A1
(43) Pub. Date: Feb. 12, 2026

(54) AI 3D-RECONSTRUCTION FROM SINGLE CAMERA AND MULTIPLE ILLUMINATION ANGLES

(71) Applicant: Orbotech LTD., Yavne (IL)

(72) Inventors: Hagit Schechter, Mazkeret Batya (IL); Kenny Goossens, Scherpenheuvel (BE)

(21) Appl. No.: 18/898,016

(22) Filed: Sep. 26, 2024

Related U.S. Application Data
(60) Provisional application No. 63/680,884, filed on Aug. 8, 2024.

(51) Int. Cl. G06T 7/586; G06T 7/00

(52) U.S. Cl. CPC G06T 7/586; G06T 7/001; G06T 2207/10028; G06T 2207/20081; G06T 2207/30148; G06T 2207/30164

(57) ABSTRACT

The system includes a plurality of light sources each provided at a different illumination angle and configured to generate a beam of light, a stage configured to hold a workpiece in the path of the beam of light from each illumination angle, a detector configured to capture a plurality of images of the workpiece based on the beam of light reflected from the workpiece at each illumination angle, a processor in electronic communication with the detector, and an electronic data storage unit in electronic communication with the processor and storing an AI model. The processor is configured to generate a 3D height map of the workpiece based on the plurality of images of the workpiece received from the detector using the AI model. The 3D height map includes a peak height of a 3D surface feature defined on a surface of the workpiece relative to the surface of the workpiece.

### CROSS-REFERENCE TO RELATED APPLICATIONS

This application claims priority to U.S. Provisional Application No. 63/680,884, filed Aug. 8, 2024, the entire disclosure of which is hereby incorporated by reference herein.

### FIELD OF THE DISCLOSURE

This disclosure relates to semiconductor inspection and, more particularly, to a semiconductor defect detection using artificial intelligence (AI) models.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a workpiece, such as a semiconductor wafer, using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etch, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. As design rules shrink, the population of potentially yield-relevant defects detected by inspection grows dramatically, and the population of nuisance defects detected by inspection also increases dramatically. Therefore, more defects may be detected on the wafers, and correcting the processes to eliminate all of the defects may be difficult and expensive. Determining which of the defects actually have an effect on the electrical parameters of the devices and the yield may allow process control methods to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

One type of manufacturing defect commonly found in consumer electronic parts (e.g., semiconductor wafers, integrated circuits (ICs), printed circuit boards (PCBs), flat panel displays (FPDs), etc.) are 3D defects. 3D defects can include, for example, a ditch-down of material that can cause PCB malfunctioning, uneven ball grid array (BGA) ball heights that can cause assembly issues, and other types of three-dimensional defects. A lack of understanding of the height/depth of 3D defects can impact manufacturing yield.

Some 3D measurement techniques require running expensive, dedicated measurement equipment that have slow inspection time, which causes them to run in a statistical fashion as a post-process check. This means that some items are not inspected, and the production flow is delayed. Other lower costs techniques can be introduced for in-line inspection, but these techniques sacrifice accuracy for improved speed. These techniques may utilize various algorithms that increase the hardware cost and slow-down the production pipeline. For example, depth from focus algorithms may require capturing several different vertical height images, stereo algorithms may require capturing images from several different camera positions, and phase-shift algorithms may require capturing several images and pattern screening, which each add hardware cost to the inspection system and can suffer from accuracy reduction in various lighting and geometry scenarios.

Therefore, what is needed is an improved process for inspecting 3D defects in a workpiece.

### BRIEF SUMMARY OF THE DISCLOSURE

An embodiment of the present disclosure provides a system. The system may comprise a plurality of light sources each provided at a different illumination angle and configured to generate a beam of light. The system may further comprise a stage configured to hold a workpiece in a path of the beam of light from each illumination angle. A three-dimensional (3D) surface feature may be defined on a surface of the workpiece. The system may further comprise a detector configured to capture a plurality of images of the workpiece based on the beam of light reflected from the workpiece from each illumination angle. The system may further comprise a processor in electronic communication with the detector. The processor may be configured to generate a 3D height map of the workpiece based on the plurality of images of the workpiece received from the detector using an artificial intelligence (AI) model. The 3D height map may comprise a peak height of the 3D surface feature relative to the surface of the workpiece. The system may further comprise an electronic data storage unit in electronic communication with the processor. The AI model may be stored on the electronic data storage unit.

In some embodiments, the 3D surface feature may comprise a ball grid array (BGA) disposed on the surface of the workpiece, and the 3D height map may comprise peak heights of each ball of the BGA relative to the surface of the workpiece.

In some embodiments, the 3D height map may further comprise minimum heights of each ball of the BGA relative to the surface of the workpiece.

In some embodiments, the AI model may comprise a photometric 3D model configured to output the 3D height map based on position information, direction information, and illumination information of the plurality of images of the workpiece.

In some embodiments, the processor may be further configured to determine a height class of each pixel of the plurality of images of the workpiece using the AI model; and generate the 3D height map of the workpiece based on the height class of each pixel.

In some embodiments, the height class of each pixel may comprise one of a plurality of height classes, and each of the plurality of height classes may be assigned different colors in the 3D height map.

In some embodiments, the 3D height map may comprise a point cloud visualization or a gradient image, in which the different colors indicate the height class of each pixel that defines the 3D surface feature.

In some embodiments, the processor may be further configured to receive a plurality of first reference images of reference workpieces and first depth information measured for each reference workpiece using a depth camera, wherein each first reference image is captured at one of a plurality of illumination angles; and train the AI model based on the plurality of first reference images and the first depth information.

In some embodiments, the processor may be further configured to: receive a plurality of second reference images of reference workpieces and second depth information measured for each reference workpiece, wherein each second reference image is captured at one of a plurality of illumination angles, and the second depth information is measured using a higher accuracy inspection tool compared to the depth camera used to measure the first depth information; and retrain the AI model based on the plurality of second reference images and the second depth information.

In some embodiments, a quantity of the plurality of second reference images may be less than a quantity of the plurality of first reference images.

Another embodiment of the present disclosure provides a method. The method may comprise receiving, at a processor, a plurality of images of a workpiece. Each image may be captured based on a beam of light reflected from the workpiece from a different illumination angle, and a three-dimensional (3D) surface feature may be defined on a surface of the workpiece. The method may further comprise generating a 3D height map of the workpiece based on the plurality of images of the workpiece using an artificial intelligence (AI) model. The 3D height map may comprise a peak height of the 3D surface feature relative to the surface of the workpiece.

In some embodiments, the 3D surface feature may comprise a ball grid array (BGA) disposed on the surface of the workpiece, and the 3D height map may comprise peak heights of each ball of the BGA relative to the surface of the workpiece.

In some embodiments, generating the 3D height map of the workpiece may comprise determining a height class of each pixel of the plurality of images of the workpiece using the AI model; and generating the 3D height map of the workpiece based on the height class of each pixel.

In some embodiments, the method may further comprise receiving a plurality of first reference images of reference workpieces and first depth information measured for each reference workpiece using a depth camera, wherein each first reference image is captured at one of a plurality of illumination angles; and training the AI model based on the plurality of first reference images and the first depth information.

In some embodiments, the method may further comprise receiving a plurality of second reference images of reference workpieces and second depth information measured for each reference workpiece, wherein each second reference image is captured at one of a plurality of illumination angles, and the second depth information is measured using a higher accuracy inspection tool compared to the depth camera used to measure the first depth information; and retraining the AI model based on the plurality of second reference images and the second depth information.

Another embodiment of the present disclosure provides a non-transitory computer-readable storage medium. The non-transitory computer-readable storage medium may comprise one or more programs which, when executed by a processor, may cause the processor to receive a plurality of images of a workpiece, wherein each image is captured with a detector based on a beam of light reflected from the workpiece at a different illumination angle, and a three-dimensional (3D) surface feature is defined on a surface of the workpiece; and generate a 3D height map of the workpiece based on the plurality of images of the workpiece received from the detector using an artificial intelligence (AI) model, wherein the 3D height map comprises a peak height of the 3D surface feature relative to the surface of the workpiece.

In some embodiments, the 3D surface feature may comprise a ball grid array (BGA) disposed on the surface of the workpiece, and the 3D height map may comprise peak heights of each ball of the BGA relative to the surface of the workpiece.

In some embodiments, the processor may be further caused to determine a height class of each pixel of the plurality of images of the workpiece using the AI model; and generate the 3D height map of the workpiece based on the height class of each pixel.

In some embodiments, the processor may be further caused to receive a plurality of first reference images of reference workpieces and first depth information measured for each reference workpiece using a depth camera, wherein each first reference image is captured at one of a plurality of illumination angles; and train the AI model based on the plurality of first reference images and the first depth information.

In some embodiments, the processor may be further caused to receive a plurality of second reference images of reference workpieces and second depth information measured for each reference workpiece, wherein each second reference image is captured at one of a plurality of illumination angles, and the second depth information is measured using a higher accuracy inspection tool compared to the depth camera used to measure the first depth information; and retrain the AI model based on the plurality of second reference images and the second depth information.

### DESCRIPTION OF THE DRAWINGS

For a fuller understanding of the nature and objects of the disclosure, reference should be made to the following detailed description taken in conjunction with the accompanying drawings, in which:

FIG. 1 is a flowchart of a method according to an embodiment of the present disclosure;

FIG. 2 is a flowchart of a method according to another embodiment of the present disclosure;

FIG. 3 is a flowchart of a method according to another embodiment of the present disclosure;

FIG. 4 is a diagram of a system according to an embodiment of the present disclosure;

FIG. 5 is a top view of an arrangement of light sources of the system of FIG. 4;

FIG. 6 is a data flow diagram according to an embodiment of the present disclosure;

FIG. 7 is a data flow diagram according to another embodiment of the present disclosure;

FIG. 8A is an exemplary point cloud visualization according to embodiments of the present disclosure;

FIG. 8B is an exemplary gradient image according to embodiments of the present disclosure; is a data flow diagram according to another embodiment of the present disclosure; and

FIG. 9 is a data flow diagram according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

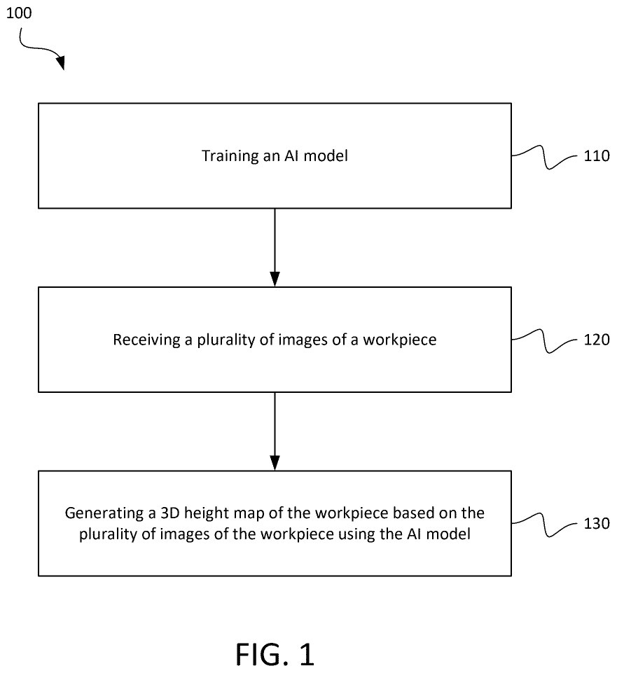

An embodiment of the present disclosure provides a method 100, as shown in FIG. 1. The method 100 may comprise the following steps.

At step 120, a plurality of images of a workpiece are received. The workpiece may be a semiconductor wafer, substrate, die, printed circuit board (PCB), integrated circuit (IC) or other substrate packaging, flat panel display (FPD) or other type of workpiece. A three-dimensional (3D) surface feature may be defined on a surface of the workpiece. The 3D surface feature may protrude from the surface of the workpiece or may be a ditch down into the surface of the workpiece. The 3D surface feature may include a capacitor height, a die height, a lead height (e.g., leads of an IC such as a quad flat package (QFP)), substrate warpage, total package height, micro bumps (e.g., those used for chip-to-chip or chip-to-substrate connections), or other features, which may depend on the particular type of substrate used. In an instance, the 3D surface feature may comprise a ball grid array (BGA) disposed on the surface of the workpiece. Each ball of the BGA may be used to connect electrical components to the workpiece, and consistent heights of each ball of the BGA may allow for consistent electrical connections. Defects may occur, for example, where a ball of the BGA has a height that is too high or too low relative to the surface of the workpiece, or where the workpiece is warped. Thus, the plurality of images of the workpiece may be captured to inspect the workpiece for such defects.

The plurality of images of the workpiece may be captured based on beams of light directed at the workpiece from different illumination angles. For example, the different illumination angles may be configured to direct beams of light at the front, back, left, and right of the workpiece, at one or more oblique angles relative to the surface of the workpiece (e.g., any angle between 0 and 9 degrees) or coaxial (i.e., normal) to the surface of the workpiece. A plurality of light sources may be each provided at a different illumination angle to direct their respective beams of light onto the workpiece at each illumination angle. In some embodiments, at least one image of the workpiece may be captured with each illumination angle. For example, one light source of the plurality of light sources may be configured to generate a beam of light to illuminate the workpiece, while the other light sources are turned off or their beams of light are blocked from illuminating the workpiece. In some embodiments, two or more light sources may be configured to generate beams of light to simultaneously illuminate the workpiece to capture an image of the workpiece. For example, the front and back of the workpiece may be simultaneously illuminated or the left and right of the workpiece may be simultaneously illuminated to capture an image of the workpiece. In some embodiments, the plurality of light sources may comprise a ring light source configured to generate a beam of light having a ring shape or other types of light sources configured to generate different beam shapes. The plurality of light sources may further comprise any number of light sources to generate light from different combinations of illumination angles or specific light patterns.

At step 130, a 3D height map of the workpiece is generated based on the plurality of images of the workpiece using an AI model. The 3D height map may comprise a peak height of the 3D surface feature relative to the surface of the workpiece. For example, for each ball of the BGA, the 3D height map may indicate a peak height of each ball from the surface of the workpiece. Accordingly, the 3D height map may be used for inspection of the workpiece to identify defects where there is an inconsistency in the height of the 3D surface feature relative to the surface of the workpiece. The 3D height map may further comprise a minimum height of the 3D surface feature relative to the surface of the workpiece. For example, the minimum height may correspond to the surface of the workpiece surrounding each ball of the BGA. Accordingly, the 3D height map can be used to identify a warpage of the workpiece where the minimum height is inconsistent across the surface of the workpiece.

In some embodiments, the AI model may comprise a photometric 3D model configured to output the 3D height map based on position information, direction information, and illumination information of the plurality of images of the workpiece. For example, based on the illumination angle, wavelength, and intensity of each of the plurality of light sources used to capture the plurality of images of the workpiece, the photometric 3D model may be able to predict the height or height class of each pixel. The photometric 3D model may be further able to predict local planes of unseen data based on the heights of surrounding pixels to produce a complete 3D height map of the workpiece. In other words, the photometric 3D model may be able to predict a height of a specific location of the 3D height map given the information about illumination angles, wavelength, intensity, etc. related to the plurality of images of the workpiece (2D). For unseen data, the prediction may include an extrapolation of the data from the visible parts of the workpiece.

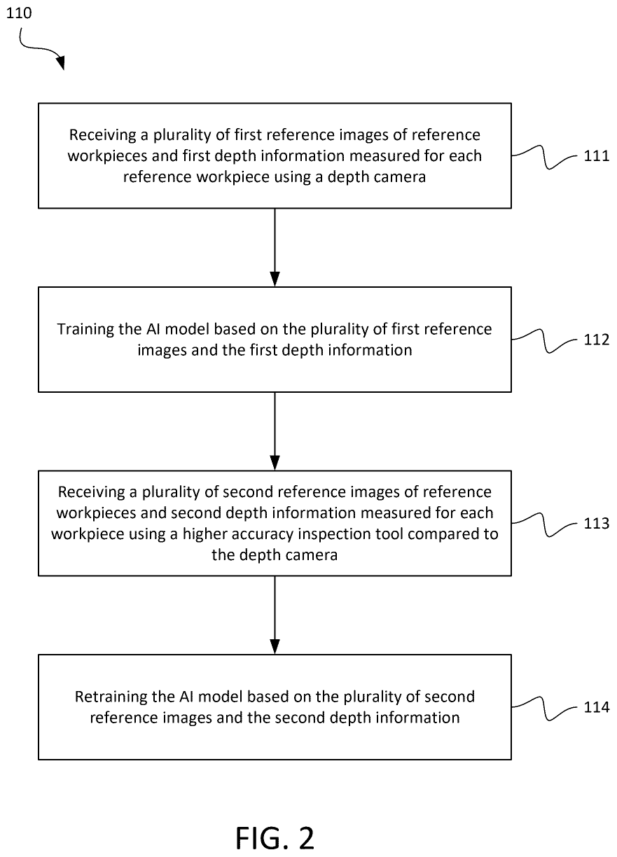

In some embodiments, the method 100 may further comprise step 110. At step 110, the AI model is trained. As shown in FIG. 2, step 110 may comprise the following steps.

At step 111, a plurality of first reference images of reference workpieces and first depth information measured for each reference workpiece using a depth camera are received. The reference workpieces may be various types of workpieces, similar to the types sought to be inspected in the embodiments of the present disclosure, and may have one or more 3D surface features defined thereon. The plurality of first reference images may be captured based on light reflected from the reference workpieces at different illumination angles and/or different field of views. The first depth information may be measurements of the relative height of each reference workpiece captured by a depth camera, and the first depth information may be assigned for each pixel of the plurality of first reference images. In some embodiments, the relative heights of the first depth information may be segmented into a plurality of height classes using attention logic. The plurality of height classes may include, for example, a peak height, mid height, low height, min height, and others. Accordingly, each pixel of the plurality of first reference images may be associated with one of the plurality of height classes.

At step 112, the AI model is trained based on the plurality of first reference images and the first depth information. For example, the AI model may be trained to associate the relative height or height classifications from the first depth information to the plurality of first reference images captured at different illumination angles, in order to predict the relative height of 3D surface features found in new images.

In some embodiments, step 110 may further comprise the following steps.

At step 113, a plurality of second reference images of workpieces and second depth information measured for each workpiece using a higher accuracy inspection tool compared to the depth camera are received. For example, the inspection tool and the depth camera may rely on different technologies (e.g., stereo vision, phase shift (structured light, chromatic confocal, white Light interferometry, etc.)) and may have different pixel resolutions. Depending on the parameters of these technologies, the measurement accuracy (i.e., deviation from real height) and repeatability (i.e., deviation between different measurements) may vary. Compared to the inspection tool, the depth camera may have lower spatial magnification, weaker light conditions, and/or lower height reconstruction technology. In contrast, the inspection tool may be a high resolution 3D microscope having a higher accuracy and repeatability for measurements that are closer to the real height, which may be based on a different reconstruction model. The plurality of second reference images may be captured based on light reflected from the reference workpieces at different illumination angles, similar to the plurality of first reference images. The second depth information may be measurements of the relative height of each reference workpiece captured using a higher accuracy inspection tool compared to depth camera used to measure the first depth information, and the second depth information may be assigned for each pixel of the plurality of second reference images.

At step 114, the AI model is retrained based on the plurality of second reference images and the second depth information. For example, the AI model may be retrained to associate the relative height from the second depth information to the plurality of second reference images captured at different illumination angles to improve the AI model for higher accuracy prediction of the relative height of 3D surface features found in new images. Accordingly, the AI model can be fine-tuned using the higher accuracy second depth information corresponding to the plurality of second reference images to improve overall inspection accuracy of the AI model.

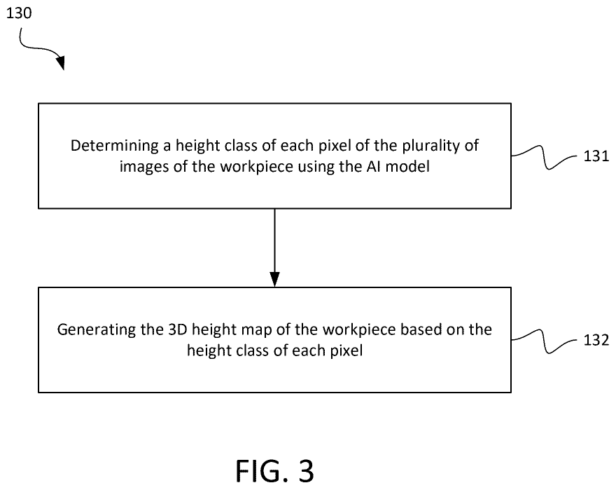

In some embodiments, step 130 may comprise the following steps, as shown in FIG. 3.

At step 131, a height class of each pixel of the plurality of images of the workpiece are determined using the AI model. For example, the AI model may be used to assign one height class of a plurality of height classes to each pixel of the plurality of images of the workpiece. The plurality of height classes may include, for example, a peak height, a mid height, a low height, a min height, or any number of height classification slices. In an instance, the peak height may correspond to the top surface of a 3D surface feature of the workpiece, the min height (i.e., minimum height) may correspond to the surface of the workpiece, and the mid height and low height may correspond to heights between the peak height and the min height.

At step 132, the 3D height map of the workpiece is generated based on the height class of each pixel. In some embodiments, the 3D height map may be a point cloud visualization or a gradient image, which indicates the various height classes of each pixel. For example, each height class may be assigned different colors, and based on the difference in appearance of the various height classes, 3D surface features of the workpiece can be visualized. Accordingly, the 3D height map can be used for inspection of defects in the workpiece, for example, where a peak height of the 3D surface feature is too high, too low, or inconsistent relative to other 3D surface features, or where min heights are inconsistent across the surface of the workpiece (i.e., lack coplanarity), which indicates warpage.

With the method 100, the AI model can be used to generate a 3D height map of the workpiece without the use of in-line 3D measurement equipment. Accordingly, the cost and time for inspection can be minimized, while still operating as an in-line inspection process, not a post-process statistical check. In addition, the AI model can be trained with a combination of low accuracy data and few-shot high accuracy data which can reduce training time and minimize the amount of high accuracy data to be collected before the method 100 can be implemented for workpiece inspection, while still achieving high accuracy detection results. The AI model can also be used to improve weaker aspects of inspection technology to provide a more robust 3D measurement system.

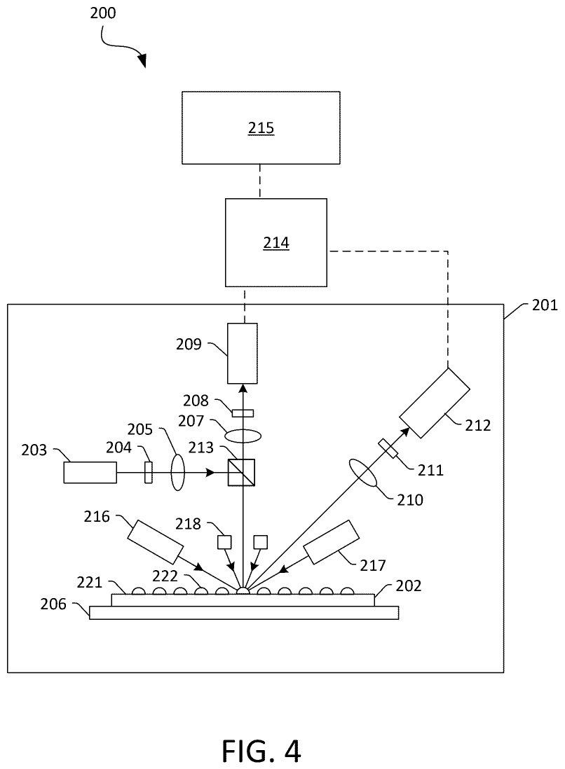

Another embodiment of the present disclosure provides an optical inspection system 200, as shown in FIG. 4. The system 200 includes optical based subsystem 201. In general, the optical based subsystem 201 is configured for generating optical based output for a specimen 202 by directing light to (or scanning light over) and detecting light from the specimen 202. In one embodiment, the specimen 202 includes a wafer. The wafer may include any wafer known in the art, such as those used in the method 100. In another embodiment, the specimen 202 includes a reticle. The reticle may include any reticle known in the art.

In some embodiments, the specimen 202 may be a semiconductor wafer, substrate, printed circuit board (PCB), integrated circuit (IC), flat panel display (FPD) or other type of workpiece. As shown in FIG. 4, a three-dimensional (3D) surface feature 222 may be defined on a top surface 221 of the specimen 202. The 3D surface feature 222 may protrude from the top surface 221 of the specimen 202 or may be a ditch down into the top surface 221 of the specimen 202. In some embodiments, the 3D surface feature 222 may comprise a ball grid array (BGA) disposed on the top surface 221 of the specimen 202, in which each ball of the BGA protrudes from the top surface 221 of the specimen 202.

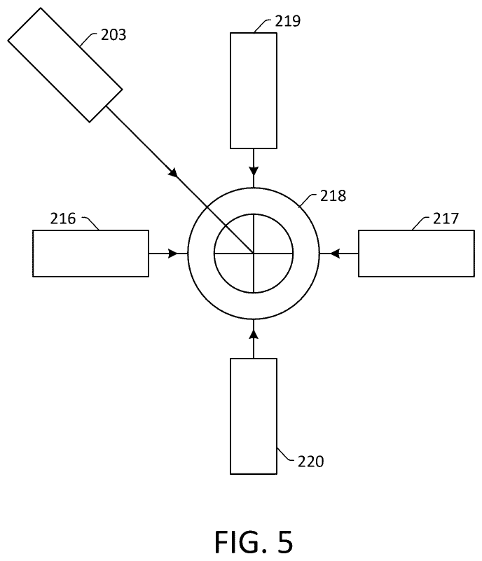

In the embodiment of the system 200 shown in FIG. 4, optical based subsystem 201 includes an illumination subsystem configured to direct light to specimen 202. The illumination subsystem includes a plurality of light sources, in which each light source is configured to direct the light to the specimen 202 at one or more angles of incidence, which may include one or more oblique angles and/or one or more normal angles. For example, as shown in FIG. 4, light from a coaxial light source 203 is directed through optical element 204 and then lens 205 to specimen 202 at a normal angle of incidence relative to the specimen 202, light from a left light source 216 and light from a right light source 217 are directed at the specimen 202 at opposite oblique angles of incidence relative to the left/right sides of the specimen 202, and light from a ring light source 218 is directed at the specimen 202 at one or more oblique angles and/or one or more normal angles relative to the specimen 202. As further shown in FIG. 5, light from a front light source 219 and light from a back light source 220 are directed at the specimen 202 at opposite oblique angles of incidence relative to the front/back sides of the specimen 202. The oblique angles of incidence of the left light source 216, the right light source 217, the front light source 219, and the back light source 220 may include any suitable oblique angles of incidence, which may vary depending on, for instance, characteristics of the specimen 202. The plurality of light sources may be configured to generate light in the visible wavelength spectrum, infrared wavelength spectrum, and/or the ultraviolet wavelength spectrum. The plurality of light sources may each be configured to operate at the same wavelength, or different combinations of wavelengths can be used (e.g., blue and red). The plurality of light sources may also generate light having different illumination intensities.

The optical based subsystem 201 may be configured to direct the light to the specimen 202 at different angles of incidence at different times. For example, the optical based subsystem 201 may be configured to alter one or more characteristics of one or more elements of the illumination subsystem such that the light can be directed to the specimen 202 at an angle of incidence that is different than that shown in FIG. 4. In one such example, the optical based subsystem 201 may be configured to move light source 203, optical element 204, and lens 205 such that the light is directed to the specimen 202 at a different oblique angle of incidence or a normal (or near normal) angle of incidence. Alternatively, the optical based subsystem 201 may be configured to turn on one or more of the coaxial light source 203, the left light source 216, the right light source 217, the ring light source 218, the front light source 219, or the back light source 220, while the other light sources are turned off or blocked from illuminating the specimen 202.

In some instances, the optical based subsystem 201 may be configured to direct light to the specimen 202 at more than one angle of incidence at the same time. For example, the illumination subsystem may include more than one illumination channel, one of the illumination channels may include the coaxial light source 203, optical element 204, and lens 205 as shown in FIG. 4, and other illumination channels may include the left light source 216, the right light source 217, the ring light source 218, the front light source 219, or the back light source 220 and similar elements, which may be configured differently or the same, or may include at least a light source and possibly one or more other components such as those described further herein. If such light is directed to the specimen 202 at the same time as the other light, one or more characteristics (e.g., wavelength, polarization, etc.) of the light directed to the specimen 202 at different angles of incidence may be different such that light resulting from illumination of the specimen 202 at the different angles of incidence can be discriminated from each other at the detector(s). For example, light from the left light source 216 and light from the right light source 217 may be directed to the specimen 202 at the same time, or light from the front light source 219 and light from the back light source 220 may be directed to the specimen at the same time.

In another instance, the illumination subsystem may include only one light source (e.g., light source 203 shown in FIG. 4) and light from the light source may be separated into different optical paths (e.g., based on wavelength, polarization, etc.) by one or more optical elements (not shown) of the illumination subsystem. Light in each of the different optical paths may then be directed to the specimen 202 at different angles of incidence. Multiple illumination channels may be configured to direct light to the specimen 202 at the same time or at different times (e.g., when different illumination channels are used to sequentially illuminate the specimen). In another instance, the same illumination channel may be configured to direct light to the specimen 202 with different characteristics at different times. For example, in some instances, optical element 204 may be configured as a spectral filter and the properties of the spectral filter can be changed in a variety of different ways (e.g., by swapping out the spectral filter) such that different wavelengths of light can be directed to the specimen 202 at different times. The illumination subsystem may have any other suitable configuration known in the art for directing the light having different or the same characteristics to the specimen 202 at different or the same angles of incidence sequentially or simultaneously.

In one embodiment, the plurality of light sources may include a broadband plasma (BBP) source. In this manner, the light generated by each light source and directed to the specimen 202 may include broadband light. However, the light source may include any other suitable light source such as a laser. The laser may include any suitable laser known in the art and may be configured to generate light at any suitable wavelength or wavelengths known in the art. In addition, the laser may be configured to generate light that is monochromatic or nearly-monochromatic. In this manner, the laser may be a narrowband laser. The plurality of light sources may also include a polychromatic light source that generates light at multiple discrete wavelengths or wavebands.

Light from optical element 204 may be focused onto specimen 202 by lens 205. Although lens 205 is shown in FIG. 4 as a single refractive optical element, it is to be understood that, in practice, lens 205 may include a number of refractive and/or reflective optical elements that in combination focus the light from the optical element to the specimen. The illumination subsystem shown in FIG. 4 and described herein may include any other suitable optical elements (not shown). Examples of such optical elements include, but are not limited to, polarizing component(s), spectral filter(s), spatial filter(s), reflective optical element(s), apodizer(s), beam splitter(s) (such as beam splitter 213), aperture(s), and the like, which may include any such suitable optical elements known in the art. In addition, the optical based subsystem 201 may be configured to alter one or more of the elements of the illumination subsystem based on the type of illumination to be used for generating the optical based output.

The optical based subsystem 201 may also include a scanning subsystem configured to cause the light to be scanned over the specimen 202. For example, the optical based subsystem 201 may include stage 206 on which specimen 202 is disposed during optical based output generation. The scanning subsystem may include any suitable mechanical and/or robotic assembly (that includes stage 206) that can be configured to move the specimen 202 such that the light can be scanned over the specimen 202. In addition, or alternatively, the optical based subsystem 201 may be configured such that one or more optical elements of the optical based subsystem 201 perform some scanning of the light over the specimen 202. The light may be scanned over the specimen 202 in any suitable fashion such as in a serpentine-like path or in a spiral path.

The optical based subsystem 201 further includes one or more detection channels. At least one of the one or more detection channels includes a detector configured to detect light from the specimen 202 due to illumination of the specimen 202 by the subsystem and to generate output responsive to the detected light. For example, the optical based subsystem 201 shown in FIG. 4 includes two detection channels, one formed by collector 207, element 208, and detector 209 and another formed by collector 210, element 211, and detector 212. As shown in FIG. 4, the two detection channels are configured to collect and detect light at different angles of collection. In some instances, both detection channels are configured to detect scattered light, and the detection channels are configured to detect light that is scattered at different angles from the specimen 202. However, one or more of the detection channels may be configured to detect another type of light from the specimen 202 (e.g., reflected light).

As further shown in FIG. 4, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 210, element 211, and detector 212 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 4 shows an embodiment of the optical based subsystem 201 that includes two detection channels, the optical based subsystem 201 may include a different number of detection channels (e.g., only one detection channel or two or more detection channels). In one such instance, the detection channel formed by collector 210, element 211, and detector 212 may form one side channel as described above, and the optical based subsystem 201 may include an additional detection channel (not shown) formed as another side channel that is positioned on the opposite side of the plane of incidence. Therefore, the optical based subsystem 201 may include the detection channel that includes collector 207, element 208, and detector 209 and that is centered in the plane of incidence and configured to collect and detect light at scattering angle(s) that are at or close to normal to the specimen 202 surface. This detection channel may therefore be commonly referred to as a “top” channel, and the optical based subsystem 201 may also include two or more side channels configured as described above. As such, the optical based subsystem 201 may include at least three channels (i.e., one top channel and two side channels), and each of the at least three channels has its own collector, each of which is configured to collect light at different scattering angles than each of the other collectors. In some embodiments, the system 200 may include additional optical based subsystems having different detection channels.

As described further above, each of the detection channels included in the optical based subsystem 201 may be configured to detect scattered light. Therefore, the optical based subsystem 201 shown in FIG. 4 may be configured for dark field (DF) output generation for specimens 202. However, the optical based subsystem 201 may also or alternatively include detection channel(s) that are configured for bright field (BF) output generation for specimens 202. In other words, the optical based subsystem 201 may include at least one detection channel that is configured to detect light specularly reflected from the specimen 202. Therefore, the optical based subsystems 201 described herein may be configured for only DF, only BF, or both DF and BF imaging. Although each of the collectors are shown in FIG. 4 as single refractive optical elements, it is to be understood that each of the collectors may include one or more refractive optical die(s) and/or one or more reflective optical element(s).

The one or more detection channels may include any suitable detectors known in the art. For example, the detectors may include photo-multiplier tubes (PMTs), charge coupled devices (CCDs), complementary metal-oxide-semiconductor (CMOS) sensors, time delay integration (TDI) cameras, and any other suitable detectors known in the art. The detectors may also include non-imaging detectors or imaging detectors. In this manner, if the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels of the optical based subsystem may be signals or data, but not image signals or image data. In such instances, a processor such as processor 214 may be configured to generate images of the specimen 202 from the non-imaging output of the detectors. However, in other instances, the detectors may be configured as imaging detectors that are configured to generate imaging signals or image data. Therefore, the optical based subsystem may be configured to generate optical images or other optical based output described herein in a number of ways.

It is noted that FIG. 4 is provided herein to generally illustrate a configuration of an optical based subsystem 201 that may be included in the system embodiments described herein or that may generate optical based output that is used by the system embodiments described herein.

The optical based subsystem 201 configuration described herein may be altered to optimize the performance of the optical based subsystem 201 as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

The processor 214 may be coupled to the components of the system 200 in any suitable manner (e.g., via one or more transmission media, which may include wired and/or wireless transmission media) such that the processor 214 can receive output. The processor 214 may be configured to perform a number of functions using the output. The system 200 can receive instructions or other information from the processor 214. The processor 214 and/or the electronic data storage unit 215 optionally may be in electronic communication with an inspection tool, a metrology tool, or a review tool (not illustrated) to receive additional information or send instructions. For example, the processor 214 and/or the electronic data storage unit 215 can be in electronic communication with a scanning electron microscope.

The processor 214, other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 214 and electronic data storage unit 215 may be disposed in or otherwise part of the system 200 or another device. In an example, the processor 214 and electronic data storage unit 215 may be part of a standalone control unit or in a centralized quality control unit. Multiple processors 214 or electronic data storage units 215 may be used.

The processor 214 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 214 to implement various methods and functions may be stored in readable storage media, such as a memory in the electronic data storage unit 215 or other memory.

If the system 200 includes more than one processor 214, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 214 may be configured to perform a number of functions using the output of the system 200 or other output. For instance, the processor 214 may be configured to send the output to an electronic data storage unit 215 or another storage medium. The processor 214 may be configured according to any of the embodiments described herein. The processor 214 also may be configured to perform other functions or additional steps using the output of the system 200 or using images or data from other sources.

Various steps, functions, and/or operations of system 200 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 214 or, alternatively, multiple processors 214. Moreover, different sub-systems of the system 200 may include one or more computing or logic systems. Therefore, the above description should not be interpreted as a limitation on the present disclosure but merely an illustration.

In an instance, the processor 214 may be in electronic communication with the system 200. The processor 214 may be configured to receive a plurality of images of a workpiece (i.e., specimen 202) from the detector 209 and/or detector 212. Each of the plurality of images of the workpiece may be captured at different angles of illumination, for example, based on light directed from one or more of the coaxial light source 203, the left light source 216, the right light source 217, the ring light source 218, the front light source 219, and the back light source 220.

The processor 214 may be further configured to generate a 3D height map of the workpiece based on the plurality of images of the workpiece using an AI model. The AI model may be trained to predict a height or height class of each pixel of the images of the workpiece. For example, the AI model may be first trained with a plurality of first reference images and low accuracy first depth information of each workpiece, and then the AI model can be fine-tuned with a plurality of second reference images and higher accuracy second depth information of each workpiece, which reduces the amount of high-quality data used to train the AI model. In some embodiments, the AI model may comprise a photometric 3D model configured to output the 3D height map based on position information, direction information, and illumination information of the plurality of images of the workpiece. The 3D height map may comprise relative heights and/or height classifications of each pixel across the surface of the workpiece. For example, the 3D height map may comprise a peak height of 3D surface features 222 (e.g., balls of a BGA) relative to the top surface 221 of the workpiece. The 3D height map may further comprise one or more additional heights or height classifications, such as a mid height, a low height, or a min height, in which the min height may correspond to the top surface 221 of the workpiece, and the mid height and the low height may correspond to heights between the peak height and the min height. In some embodiments, the 3D height map may comprise a point cloud visualization or a gradient image, in which different colors are used to indicate the height class of each pixel in order to define the 3D surface feature. Accordingly, the 3D height map may provide a visualization of the 3D surface features of the workpiece and can be used for inspection. Inspected defects may include, for example, inconsistencies in the peak heights of the 3D surface features 222 and/or inconsistencies in the min heights of the top surface 221 of the workpiece, which can indicate warpage.

With the system 200, the AI model can be used to generate a 3D height map of the workpiece without the use of in-line 3D measurement equipment. Accordingly, the cost and time for inspection can be minimized, while still operating as an in-line inspection process, not a post-process statistical check. In addition, the AI model can be trained with a combination of low accuracy data and few-shot high accuracy data which can reduce training time and minimize the amount of high accuracy data to be collected before the system 200 can implement workpiece inspection, while still achieving high accuracy detection results. The AI model can also be used to improve weaker aspects of inspection technology to provide a more robust 3D measurement system.

An additional embodiment relates to a non-transitory computer-readable medium storing program instructions executable on a controller for performing a computer-implemented method for inspection, as disclosed herein. In particular, as shown in FIG. 4, electronic data storage unit 215 or other storage medium may contain non-transitory computer-readable medium that includes program instructions executable on the processor 214. The computer-implemented method may include any step(s) of any method(s) described herein, including method 100.

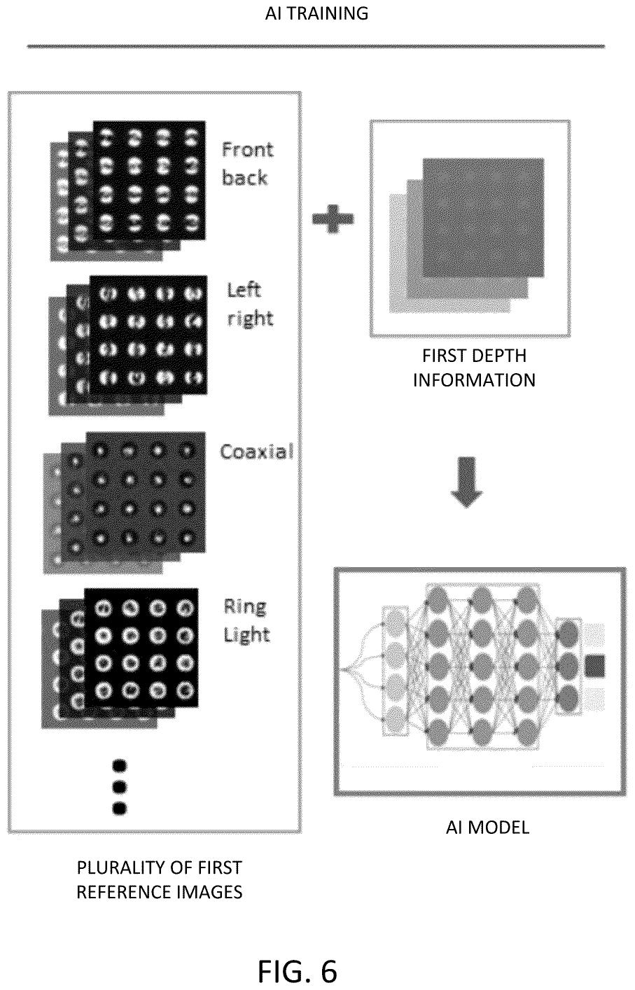

FIG. 6 is a data flow diagram illustrating the computer-implemented process of training the AI model executed by the processor 214 and the electronic data storage unit 215 of the system 200 or of a different system/subsystem in communication with the system 200. As shown in FIG. 6, a plurality of first reference images of reference workpieces are received by the processor 214, along with first depth information of each reference workpiece. The reference workpieces may be various types of workpieces, similar to the types sought to be inspected in the embodiments of the present disclosure, and may have one or more 3D surface features defined thereon. The plurality of first reference images may be captured based on light reflected from the reference workpieces at different illumination angles. The first depth information may be measurements of the relative height of each reference workpiece captured by a depth camera, and the first depth information may be assigned for each pixel of the plurality of first reference images. In some embodiments, the relative heights of the first depth information may be segmented into a plurality of height classes using attention logic. The plurality of height classes may include, for example, a peak height, mid height, low height, min height, and others. Accordingly, each pixel of the plurality of first reference images may be associated with one of the plurality of height classes. The AI model may therefore be trained to associate the relative height or the height classifications from the first depth information to the plurality of first reference images captured at different illumination angles. The AI model may be stored on the electronic data storage unit 215.

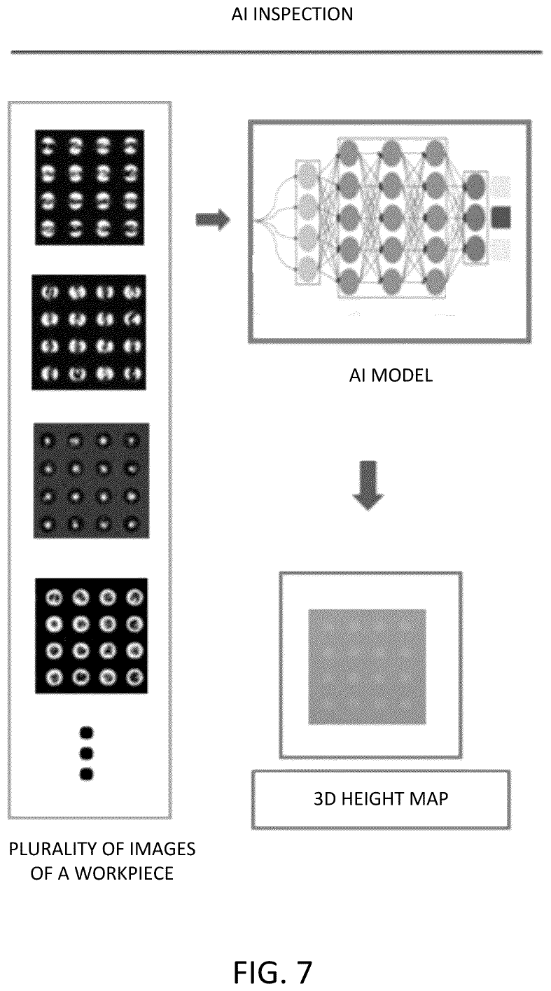

FIG. 7 is a data flow diagram illustrating the computer-implemented process of generating a 3D height map a workpiece executed by the processor 214 and the electronic data storage unit 215 of the system 200 or of a different system/subsystem in communication with the system 200. As shown in FIG. 7, the processor 214 may receive a plurality of images of the workpiece captured at different illumination angles, which are input into the AI model to obtain a 3D height map of the workpiece. The 3D height map of the workpiece may include, for example, indications of various height classifications of each pixel of the images of the workpiece, which correspond to the relative height of 3D surface features of the workpiece.

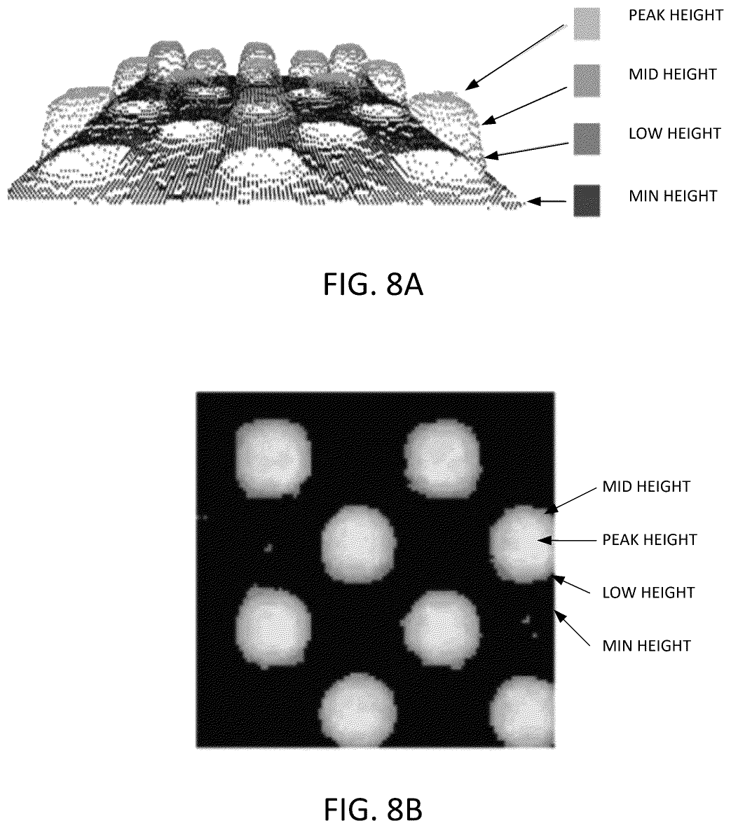

In some embodiments, the 3D height map may be a point cloud visualization, as shown in FIG. 8A. Alternatively, the 3D height map may be a gradient image, as shown in FIG. 8B. The 3D height map may include different colors which indicate the height class of each pixel. For example, the 3D height map may include different colors to define one or more of a plurality of height classes, such as a peak height, a mid height, a low height, and a min height. The different colors used herein may be different hues, grayscale levels, patterns, or other types of visual contrast to distinguish the different height classes. Based on the difference in appearance of the various height classes, 3D surface features of the workpiece can be visualized in the 3D height map, which can be used for inspection defects where a peak height of the 3D surface feature is too high, too low, or inconsistent with peak heights of surrounding 3D surface features. In addition, the 3D height map can be used to measure warpage of the workpiece where min heights are inconsistent across the surface of the workpiece (i.e., lack coplanarity). In some embodiments, different post-processing steps (e.g., image filtering, shape fitting, etc.) can be performed on the 3D height map to assist with the comparison of height measurements to CAD data and tolerances.

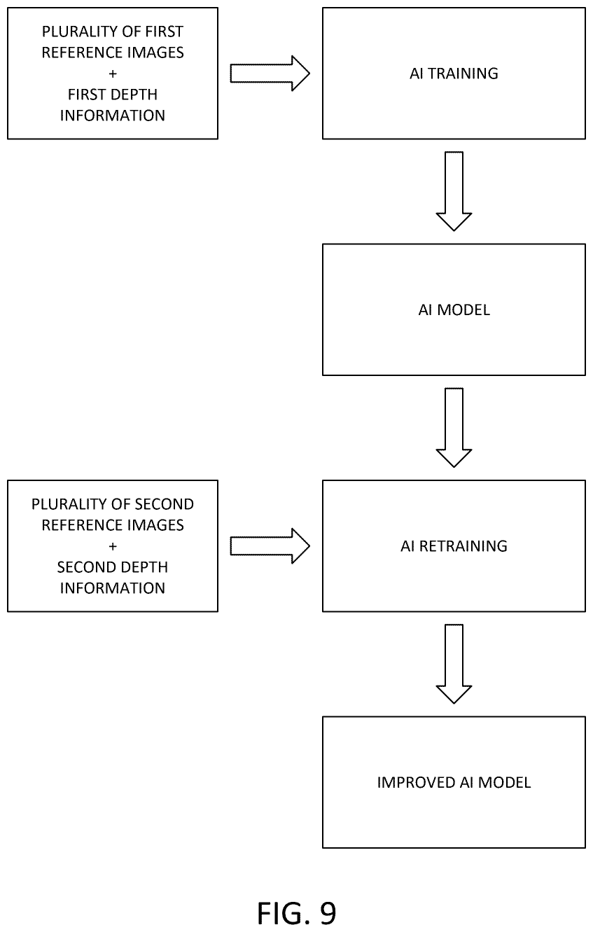

FIG. 9 is a data flow diagram illustrating the computer implemented process of further training the AI model executed by the processor 214 and the electronic data storage unit 215 of the system 200 or of a different system/subsystem in communication with the system 200. As shown in FIG. 9, after the AI model is trained (in a process similar to that shown in FIG. 6), a plurality of second reference images of workpieces are received by the processor 214, along with second depth information. The plurality of second reference images may be captured based on light reflected from the reference workpieces at different illumination angles, similar to the plurality of first reference images. The second depth information may be measurements of the relative height of each reference workpiece captured using a higher accuracy inspection tool compared to depth camera used to measure the first depth information, and the second depth information may be assigned for each pixel of the plurality of second reference images. In some embodiments, the relative heights of the second depth information may be segmented into a plurality of height classes using attention logic, similar to the first depth information. The AI model may therefore be retrained to associate the relative height or the height classifications from the second depth information to the plurality of second reference images captured at different illumination angles to improve the AI model.

In the process of further training the AI model, a quantity of the plurality of second reference images may be less than a quantity of the plurality of first reference images. In other words, the AI model may be first trained by a large quantity of lower accuracy first depth information, and then the AI model can be fine-tuned with further training using a smaller quantity of higher accuracy second depth information. Accordingly, the amount of high-quality 3D information used to train the AI model may be reduced, yet high accuracy can still be achieved.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (MFC), Streaming SIMD Extension (SSE), or other technologies or methodologies, as desired.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

The AI models described herein may be deep learning models. Rooted in neural network technology, deep learning is a probabilistic graph model with many neuron layers, commonly known as a deep architecture. Deep learning technology processes the information such as image, text, voice, and so on in a hierarchical manner. In using deep learning in the present disclosure, feature extraction is accomplished automatically using learning from data. For example, defects can be classified, sorted, or binned using the deep learning classification module based on the one or more extracted features.

Generally speaking, deep learning (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a deep network, there are many layers between the input and output, allowing the algorithm to use multiple processing layers, composed of multiple linear and non-linear transformations.

Deep learning is part of a broader family of machine learning methods based on learning representations of data. An observation (e.g., a feature to be extracted for reference) can be represented in many ways such as a vector of intensity values per pixel or in a more abstract way like a set of edges, regions of particular shape, etc. Some representations are better than others at simplifying the learning task (e.g., face recognition or facial expression recognition). Deep learning can provide efficient algorithms for unsupervised or semi-supervised feature learning and hierarchical feature extraction.

In an embodiment, the deep learning models of the AI models of the present disclosure may be configured as neural networks. In a further embodiment, the deep learning models may be deep neural networks with a set of weights that model the world according to the data that it has been fed to train it. Neural networks can be generally defined as a computational approach based on a relatively large collection of neural units loosely modeling the way a biological brain solves problems with relatively large clusters of biological neurons connected by axons. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Neural networks typically include multiple layers, and the signal path traverses from front to back. The goal of the neural network is to solve problems in the same way that the human brain would, although several neural networks are much more abstract. Modern neural network projects typically work with a few thousand to a few million neural units and millions of connections. The neural network may have any suitable architecture and/or configuration known in the art.

Generative adversarial networks (GANs) provide generative modeling using deep learning methods, such as convolutional neural networks. Generative modeling is an unsupervised learning task in machine learning that involves automatically discovering and learning the regularities or patterns in input data so that the model can be used to generate or output new examples that plausibly could have been determined from the original dataset.

GANs train a generative model by framing the problem as a supervised learning problem with two sub-models. First, there is a generator model that is trained to generate new examples. Second, there is a discriminator model that tries to classify examples as either real (from the domain) or fake (generated). The two models are trained together in a zero-sum game (i.e., adversarial) until the discriminator model is fooled enough that the generator model is generating plausible examples.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a plurality of light sources each provided at a different illumination angle and configured to generate a beam of light;
a stage configured to hold a workpiece in a path of the beam of light from each illumination angle, wherein a three-dimensional (3D) surface feature is defined on a surface of the workpiece;
a detector configured to capture a plurality of images of the workpiece based on the beam of light reflected from the workpiece from each illumination angle;
a processor in electronic communication with the detector, wherein the processor is configured to generate a 3D height map of the workpiece based on the plurality of images of the workpiece received from the detector using an artificial intelligence (AI) model, and the 3D height map comprises a peak height of the 3D surface feature relative to the surface of the workpiece; and
an electronic data storage unit in electronic communication with the processor, wherein the AI model is stored on the electronic data storage unit.

2. The system of claim 1, wherein the 3D surface feature comprises a ball grid array (BGA) disposed on the surface of the workpiece, and the 3D height map comprises peak heights of each ball of the BGA relative to the surface of the workpiece.

3. The system of claim 2, wherein the 3D height map further comprises minimum heights of each ball of the BGA relative to the surface of the workpiece.

4. The system of claim 1, wherein the AI model comprises a photometric 3D model configured to output the 3D height map based on position information, direction information, and illumination information of the plurality of images of the workpiece.

5. The system of claim 1, wherein the processor is further configured to:
determine a height class of each pixel of the plurality of images of the workpiece using the AI model; and
generate the 3D height map of the workpiece based on the height class of each pixel.

6. The system of claim 5, wherein the height class of each pixel comprises one of a plurality of height classes, and each of the plurality of height classes are assigned different colors in the 3D height map.

7. The system of claim 6, wherein the 3D height map comprises a point cloud visualization or a gradient image, in which the different colors indicate the height class of each pixel that defines the 3D surface feature.

8. The system of claim 1, wherein the processor is further configured to:
receive a plurality of first reference images of reference workpieces and first depth information measured for each reference workpiece using a depth camera, wherein each first reference image is captured at one of a plurality of illumination angles; and
train the AI model based on the plurality of first reference images and the first depth information.

9. The system of claim 8, wherein the processor is further configured to:
receive a plurality of second reference images of reference workpieces and second depth information measured for each reference workpiece, wherein each second reference image is captured at one of a plurality of illumination angles, and the second depth information is measured using a higher accuracy inspection tool compared to the depth camera used to measure the first depth information; and
retrain the AI model based on the plurality of second reference images and the second depth information.

10. The system of claim 9, wherein a quantity of the plurality of second reference images is less than a quantity of the plurality of first reference images.

11. A method comprising:
receiving, at a processor, a plurality of images of a workpiece, wherein each image is captured based on a beam of light reflected from the workpiece from a different illumination angle, and a three-dimensional (3D) surface feature is defined on a surface of the workpiece; and
generating a 3D height map of the workpiece based on the plurality of images of the workpiece using an artificial intelligence (AI) model, wherein the 3D height map comprises a peak height of the 3D surface feature relative to the surface of the workpiece.

12. The method of claim 11, wherein the 3D surface feature comprises a ball grid array (BGA) disposed on the surface of the workpiece, and the 3D height map comprises peak heights of each ball of the BGA relative to the surface of the workpiece.

13. The method of claim 11, wherein generating the 3D height map of the workpiece comprises:
determining a height class of each pixel of the plurality of images of the workpiece using the AI model; and
generating the 3D height map of the workpiece based on the height class of each pixel.

14. The method of claim 11, further comprising:
receiving a plurality of first reference images of reference workpieces and first depth information measured for each reference workpiece using a depth camera, wherein each first reference image is captured at one of a plurality of illumination angles; and
training the AI model based on the plurality of first reference images and the first depth information.

15. The method of claim 14, further comprising:
receiving a plurality of second reference images of reference workpieces and second depth information measured for each reference workpiece, wherein each second reference image is captured at one of a plurality of illumination angles, and the second depth information is measured using a higher accuracy inspection tool compared to the depth camera used to measure the first depth information; and
retraining the AI model based on the plurality of second reference images and the second depth information.

16. A non-transitory computer-readable storage medium comprising one or more programs which, when executed by a processor, cause the processor to:
receive a plurality of images of a workpiece, wherein each image is captured with a detector based on a beam of light reflected from the workpiece at a different illumination angle, and a three-dimensional (3D) surface feature is defined on a surface of the workpiece; and
generate a 3D height map of the workpiece based on the plurality of images of the workpiece received from the detector using an artificial intelligence (AI) model, wherein the 3D height map comprises a peak height of the 3D surface feature relative to the surface of the workpiece.

17. The non-transitory computer-readable storage medium of claim 16, wherein the 3D surface feature comprises a ball grid array (BGA) disposed on the surface of the workpiece, and the 3D height map comprises peak heights of each ball of the BGA relative to the surface of the workpiece.

18. The non-transitory computer-readable storage medium of claim 16, wherein the processor is further caused to:
determine a height class of each pixel of the plurality of images of the workpiece using the AI model; and
generate the 3D height map of the workpiece based on the height class of each pixel.

19. The non-transitory computer-readable storage medium of claim 16, wherein the processor is further caused to:
receive a plurality of first reference images of reference workpieces and first depth information measured for each reference workpiece using a depth camera, wherein each first reference image is captured at one of a plurality of illumination angles; and
train the AI model based on the plurality of first reference images and the first depth information.

20. The non-transitory computer-readable storage medium of claim 19, wherein the processor is further caused to:
receive a plurality of second reference images of reference workpieces and second depth information measured for each reference workpiece, wherein each second reference image is captured at one of a plurality of illumination angles, and the second depth information is measured using a higher accuracy inspection tool compared to the depth camera used to measure the first depth information; and
retrain the AI model based on the plurality of second reference images and the second depth information.
